(19) United States
(12) Patent Application Publication
(10) Pub. No.: US 2015/0161533 A1
(43) Pub. Date: Jun. 11, 2015

(54) ON-DEMAND VEHICLE OPERATION MANAGEMENT DEVICE, ON-DEMAND VEHICLE OPERATION MANAGEMENT METHOD, AND ON-DEMAND VEHICLE OPERATION MANAGEMENT SYSTEM

(71) Applicants: Masayuki Kawamoto, Toyota-shi (JP); Tatsuya Morii, Nagoya-shi (JP)

(72) Inventors: Masayuki Kawamoto, Toyota-shi (JP); Tatsuya Morii, Nagoya-shi (JP)

(73) Assignee: TOYOTA JIDOSHA KABUSHIKI KAISHA, Toyota-shi, Aichi (JP)

(21) Appl. No.: 14/411,657

(22) PCT Filed: Jun. 29, 2012
(86) PCT No.: PCT/JP2012/066760

§ 371 Date: Dec. 29, 2014

(51) Int. Cl. G06Q 10/06; G06Q 50/30

(52) U.S. Cl. CPC G06Q 10/0631; G06Q 50/30

(57) ABSTRACT

A plurality of users of an on-demand bus each use an information terminal device to transmit, as a request, to an operation management center, reservation information including a desired boarding location at which to get on the bus, a desired boarding time, a boarding allowable additional time period for designating a desired boarding time slot, a desired drop-off location at which to get off the bus, a desired drop-off time, and a drop-off allowable additional time period for designating a desired drop-off time slot. The center determines an operation schedule for operating the bus, in consideration of a combination of the desired boarding time slots and the desired drop-off time slots within respective pieces of information, so that the plurality of users each get on the bus at the desired boarding location within the desired boarding time slot and get off the bus at the desired drop-off location within the desired drop-off time slot

### TECHNICAL FIELD

The present invention relates to an on-demand vehicle operation management device, an on-demand vehicle operation management method, and an on-demand vehicle operation management system, for creating an operation schedule of an on-demand vehicle based on requests received from a plurality of users and managing an operation of the on-demand vehicle in accordance with the created operation schedule.

### BACKGROUND ART

Up to now, there are known, for example, an on-demand bus operation scheduling system and a method therefor, which make use of an operation track record as disclosed in Patent Literature 1. The related-art on-demand bus operation scheduling system or the like includes: a database for storing the operation track record regarding a reservation and a track record in terms of getting on/off of a passenger; means for extracting characteristic information relating to the getting on/off of the passenger from the operation track record stored in the database in advance, and storing the extracted characteristic information and information indicating the reservation included in the operation track record corresponding to the extracted characteristic information in the database in association with each other; and means for determining, when a current situation that determines an operation schedule is consistent with a situation indicating the characteristic information, the operation schedule of an on-demand bus based on reservation information included in the operation track record corresponding to the consistent characteristic information.

Further, up to now, there are also known, for example, a ridesharing riding system, a riding information processing device, and a ridesharing riding method disclosed in Patent Literature 2. In this related-art system or the like, a traveling route of a ridesharing vehicle is classified into a “reference segment” and an “outside reference segment,” and in the “reference segment,” ridesharing partners traveling the “reference segment” equally split a fare charged in accordance with a traveling distance of the segment, while a fare for traveling the “outside reference segment” is charged on a specific user who needs the traveling of the segment.

### CITATION LIST

### Patent Literature

[PTL 1] JP 2011-22646 A

[PTL 2] JP 2004-362271 A

### SUMMARY OF INVENTION

Incidentally, the related-art systems and the like disclosed in Patent Literatures 1 and 2 are configured so that, in principle, an operation is performed in response to a request (demand) made by a user who uses an on-demand bus (ridesharing vehicle). In this case, to satisfy all the users' requests (demands), the number of operations of the on-demand bus (ridesharing vehicle) needs to be increased, which makes it difficult to determine a profitable operation schedule. Further, when the profitability is ensured while increasing the number of operations in order to satisfy the users' requests (demands) to ensure convenience, a fare (cost) borne by the user increases. Therefore, it is desired to determine the operation schedule of an on-demand vehicle efficiently and rationally.

The present invention has been made in order to solve the above-mentioned problems, and it is an object thereof to provide an on-demand operation management device, an on-demand vehicle operation management method, and an on-demand vehicle operation management system, for determining an operation schedule of an on-demand vehicle that can ensure convenience and profitability.

An on-demand vehicle operation management device according to one embodiment of the present invention for achieving the above-mentioned object includes operation management means. The operation management means creates an operation schedule of an on-demand vehicle based on requests received from a plurality of users and manages an operation of the on-demand vehicle in accordance with the created operation schedule.

A feature of one embodiment of the present invention resides in that the operation management means is configured to: acquire pieces of information serving as the requests received from the plurality of users and each including at least a desired boarding location at which to get on the on-demand vehicle, a desired boarding time slot within which to get on the on-demand vehicle at the desired boarding location, a desired drop-off location at which to get off the on-demand vehicle, and a desired drop-off time slot within which to get off the on-demand vehicle at the desired drop-off location; and determine the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot. Note that, in this case, the operation management means may include: information acquisition means for acquiring pieces of information serving as the requests received from the plurality of users and each including at least a desired boarding location at which to get on the on-demand vehicle, a desired boarding time slot within which to get on the on-demand vehicle at the desired boarding location, a desired drop-off location at which to get off the on-demand vehicle, and a desired drop-off time slot within which to get off the on-demand vehicle at the desired drop-off location; and operation schedule determination means for determining the operation schedule for operating the on-demand vehicle, in consideration of a combination of the desired boarding time slots and the desired drop-off time slots within the respective pieces of information acquired from the plurality of users by the information acquisition means, so that the plurality of users each get on the on-demand vehicle at the desired boarding location within the desired boarding time slot and get off the on-demand vehicle at the desired drop-off location within the desired drop-off time slot.

In this case, the desired boarding time slot and the desired drop-off time slot may be designated by each of the plurality of users who use the on-demand vehicle. Further, in those cases, the desired boarding time slot may include a desired boarding time at which to get on the on-demand vehicle and boarding allowable additional time periods that are added before and after the desired boarding time and are allowable for each of the plurality of users who use the on-demand vehicle, and the desired drop-off time slot may include a desired drop-off time at which to get off the on-demand vehicle and drop-off allowable additional time periods that are added before and after the desired drop-off time and are allowable for the each of the plurality of users. Further, in those cases, the desired boarding time slot and the desired drop-off time slot may be selected from among a plurality of time slots set in advance.

Further, in those cases, the operation management means may provide the plurality of users with operation schedule information indicating the determined operation schedule, and provide the plurality of users with operation situation information indicating an operation situation of the on-demand vehicle operating in accordance with the determined operation schedule. Note that, in this case, the operation management means may include information providing means for providing the plurality of users with operation schedule information indicating the operation schedule determined by the operation schedule determination means and providing the plurality of users with operation situation information indicating an operation situation of the on-demand vehicle operating in accordance with the determined operation schedule.

According to those, each user who uses the on-demand vehicle can designate the desired boarding time slot and the desired drop-off time slot, namely, the boarding allowable additional time period and the drop-off allowable additional time period. Then, the operation management means can determine the operation schedule in consideration of the combination of the desired boarding time slot and the desired drop-off time slot (boarding allowable additional time period and drop-off allowable additional time period) designated by each user. By thus determining the operation schedule, it is possible to make use of the desired boarding time slot and the desired drop-off time slot (boarding allowable additional time period and drop-off allowable additional time period), which increase and decrease in length depending on the user's schedule, effectively by the combination thereof, and it is possible to appropriately suppress an increase in the number of operations without impairing the convenience of the user. In addition, by thus determining the efficient and rational operation schedule, it is possible to operate the on-demand vehicle with profitability being ensured, with the result that the fare (cost) borne by the user can be appropriately suppressed from increasing.

Further, another feature of one embodiment of the present invention also resides in that the operation management means is configured to: determine a gain to be given to each of the plurality of users who use the on-demand vehicle depending on lengths of the desired boarding time slot and the desired drop-off time slot; and present the determined gain to the each of the plurality of users. In this case, the operation management means may be configured to: determine the gain to be given to the each of the plurality of users so that the gain becomes smaller as the lengths of the desired boarding time slot and the desired drop-off time slot become shorter; and determine the gain to be given to the each of the plurality of users so that the gain becomes larger as the lengths of the desired boarding time slot and the desired drop-off time slot become longer. Further in those cases, the gain to be given to the each of the plurality of users may relate to, for example, a fare charged when the on-demand vehicle is used.

According to those, it is possible to effectively prompt the user of the on-demand vehicle to increase the lengths of the desired boarding time slot and the desired drop-off time slot. Accordingly, it is possible to make use of the desired boarding time slot and the desired drop-off time slot (boarding allowable additional time period and drop-off allowable additional time period) more effectively by the combination thereof, and it is possible to appropriately suppress the increase in the number of operations without impairing the convenience of the user.

Further, still another feature of one embodiment of the present invention is also an on-demand vehicle operation management method for creating an operation schedule of an on-demand vehicle based on requests received from a plurality of users and managing an operation of the on-demand vehicle in accordance with the created operation schedule, the on-demand vehicle operation management method including: acquiring pieces of information serving as the requests received from the plurality of users and each including at least a desired boarding location at which to get on the on-demand vehicle, a desired boarding time slot within which to get on the on-demand vehicle at the desired boarding location, a desired drop-off location at which to get off the on-demand vehicle, and a desired drop-off time slot within which to get off the on-demand vehicle at the desired drop-off location; determining the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot; and providing the plurality of users with operation schedule information indicating the determined operation schedule, and providing the plurality of users with operation situation information indicating an operation situation of the on-demand vehicle operating in accordance with the determined operation schedule.

Further, in this case, the on-demand vehicle operation management method may further include: determining, depending on lengths of the desired boarding time slot and the desired drop-off time slot, a gain to be given to each of the plurality of users who use the on-demand vehicle so that the gain becomes smaller as the lengths of the desired boarding time slot and the desired drop-off time slot become shorter and that the gain becomes larger as the lengths of the desired boarding time slot and the desired drop-off time slot become longer; and presenting the determined gain to the each of the plurality of users.

Further, yet another feature of one of the present invention is also an on-demand vehicle operation management system including: an on-demand vehicle to be ridden by a plurality of users; an operation management center for creating an operation schedule of the on-demand vehicle based on requests received from the plurality of users, and managing an operation of the on-demand vehicle in accordance with the created operation schedule; and an information terminal device for supplying the request to the operation management center by being operated by each of the plurality of users, in which the operation management center is configured to: acquire pieces of information serving as the requests supplied by the information terminal devices from the plurality of users and each including at least a desired boarding location at which the each of the plurality of users is to get on the on-demand vehicle, a desired boarding time slot within which the each of the plurality of users is to get on the on-demand vehicle at the desired boarding location, a desired drop-off location at which the each of the plurality of users is to get off the on-demand vehicle, and a desired drop-off time slot within which the each of the plurality of users is to get off the on-demand vehicle at the desired drop-off location; determine the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot; and provide the plurality of users with operation schedule information indicating the determined operation schedule via the information terminal devices, and provide the plurality of users with operation situation information indicating an operation situation of the on-demand vehicle operating in accordance with the determined operation schedule via the information terminal devices.

Further, in this case, the operation management center may be further configured to: determine, depending on lengths of the desired boarding time slot and the desired drop-off time slot, a gain to be given to the each of the plurality of users who use the on-demand vehicle so that the gain becomes smaller as the lengths of the desired boarding time slot and the desired drop-off time slot become shorter and that the gain becomes larger as the lengths of the desired boarding time slot and the desired drop-off time slot become longer; and present the determined gain to the each of the plurality of users via the information terminal device.

### BRIEF DESCRIPTION OF DRAWINGS

FIG. 1 is a schematic diagram of an on-demand vehicle operation management system to which an on-demand vehicle operation management device according to an embodiment of the present invention can be applied.

FIG. 2 is a block diagram schematically illustrating a configuration of an information terminal device mounted to a vehicle illustrated in FIG. 1.

FIG. 3 is a block diagram schematically illustrating a configuration of an operation management center illustrated in FIG. 1.

FIG. 4 is a block diagram schematically illustrating a configuration of a portable information terminal device illustrated in FIG. 1.

FIG. 5 is a functional block diagram functionally illustrating computer program processing executed by a server (computer) illustrated in FIG. 3.

FIG. 6 shows a reservation information table according to this embodiment.

FIG. 7 is a timing chart created based on reservation information input to the reservation information table shown in FIG. 6.

### DESCRIPTION OF EMBODIMENT

Now, an on-demand vehicle operation management device according to an embodiment of the present invention (hereinafter referred to as “this device”) is described with reference to the accompanying drawings.

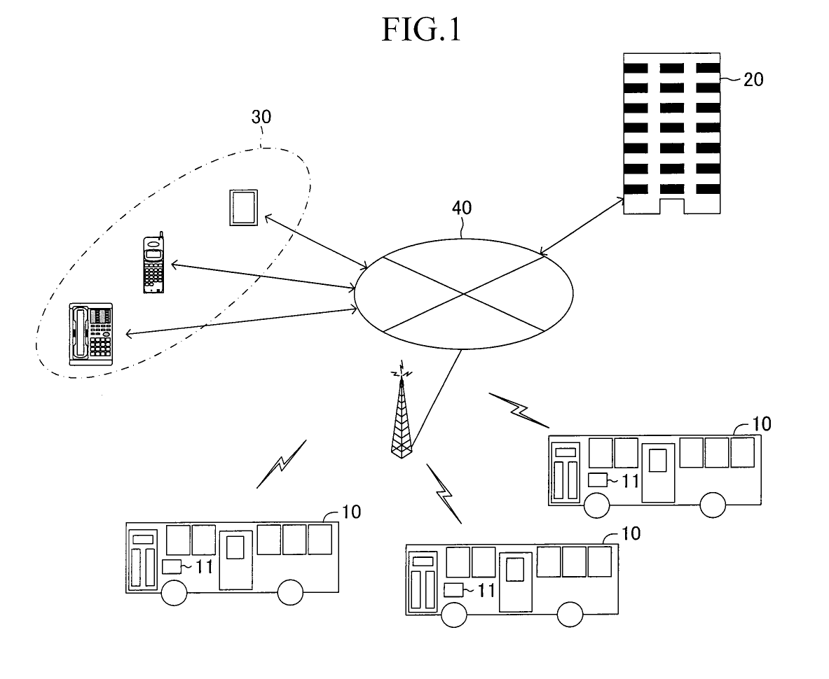

FIG. 1 illustrates a schematic configuration of an on-demand vehicle operation management system for managing an operation of an on-demand vehicle to which this device can be applied. The on-demand vehicle operation management system according to this embodiment includes: a plurality of on-demand buses 10 operated in response to a request (demand) received from a user; an operation management center 20 including this device, for determining operation schedules of the respective on-demand buses 10 and managing operations thereof; and an information terminal device 30 owned by the user. Further, in this on-demand vehicle operation management system, the respective on-demand buses 10 (more specifically, operation information terminal devices 11 described later), the operation management center 20, and the information terminal device 30 are communicably connected to each other by a network 40 such as an Internet line network or a mobile phone line network.

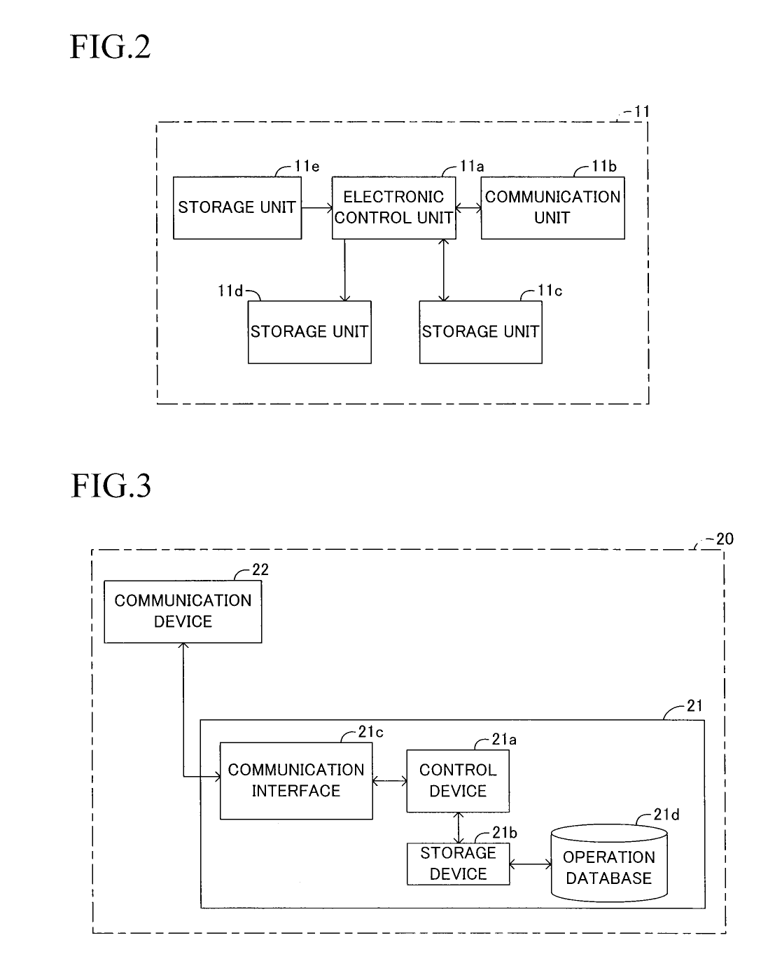

The on-demand bus 10 is a motor-omnibus in which, as well known, an operation route, operation time, and the like (hereinafter also referred to collectively as “operation schedule”) are not defined in advance and which travels within a specific region in accordance with the operation schedule determined appropriately in response to the user's request (demand) by the operation management center 20 described later. For this reason, the operation information terminal device 11 for transmitting/receiving various kinds of information including operation schedule information indicating the operation schedule through communications to/from the operation management center 20 is mounted to the on-demand bus 10. As illustrated in FIG. 2, the operation information terminal device 11 includes an electronic control unit 11a, a communication unit 11b, a storage unit 11c, an informing unit 11d, and a GPS unit 11e.

The electronic control unit 11a is a microcomputer including a CPU, a ROM, and a RAM as its main component parts, and centrally controls an operation of the operation information terminal device 11 mounted to the on-demand bus 10. The communication unit 11b is configured to realize communications to/from the operation management center 20 through radio communications performed via the network 40. The storage unit 11c includes a storage medium such as a hard disk or a semiconductor memory and a drive for driving the storage medium. Further, the storage unit 11c stores a program necessary for the electronic control unit 11a to centrally control the operation of the operation information terminal device 11 and various kinds of data including the operation schedule information, which indicates the operation schedule provided by the operation management center 20 as described later, in advance or in an updatable manner. The informing unit 11d is formed of a display, a speaker, or the like. Further, the informing unit 11d is configured to inform of the operation schedule information by displaying a character, a graphic form, or the like on a screen of the display or outputting voice from the speaker under control of the electronic control unit 11a. The GPS unit 11e is configured to receive a radio wave from a global positioning system (GPS) satellite, to detect a location of the on-demand bus 10 to which the operation information terminal device 11 is mounted.

The operation management center 20 is configured to manage the operation of the on-demand bus 10 by determining the operation schedule of the on-demand bus 10 corresponding to the user's request (demand) and providing the on-demand bus 10 with the operation schedule information. Further, the operation management center 20 is configured to provide the user with the operation schedule information and provide various kinds of information on the operation of the on-demand bus 10. For this reason, as illustrated in FIG. 3, the operation management center 20 includes a server 21 and a communication device 22.

The server 21 includes a control device 21a, a storage device 21b, and a communication interface 21c. The control device 21a includes a microcomputer formed of a CPU, a ROM, a RAM, and the like as its main component part, and centrally controls an operation of the operation management center 20 (more specifically, server 21) relating to the determination of the operation schedule and the management of the operation. The storage device 21b includes a storage medium such as a hard disk or a semiconductor memory and a drive for driving the storage medium, and stores various programs and various kinds of data. The communication interface 21c is an interface for connection to a communication line (for example, LAN line) built within the operation management center 20. Further, the storage device 21b is provided with an operation database 21d for accumulating and storing user identification information for identifying the user and various kinds of information on the user's use of the on-demand bus 10 (hereinafter also referred to as “reservation information”) in association with each other in a searchable manner. The operation database 21d further accumulates and stores bus identification information for identifying the on-demand bus 10 transmitted from the operation information terminal device 11 mounted to the on-demand bus 10 and various kinds of information involved in the operation of the on-demand bus 10 (hereinafter also referred to as “operation information”) in association with each other.

Note that, the user identification information and the bus identification information are automatically stored (registered) in the operation database 21d in a searchable manner when assigned to the corresponding user and the corresponding on-demand bus 10, respectively, in advance. At this time, the user identification information is registered in association with, for example, the user's full name, the user's home address, a latitude and a longitude indicating a location of the home, and the like. Accordingly, when the user uses, for example, the information terminal device 30 to transmit the reservation information along with the user identification information, the user identification information and the reservation information are stored in a predetermined storage location of the operation database 21d in association with each other as a reservation information table as described later. Further, when the operation information terminal device 11 transmits the operation information (specifically, positional information) along with the bus identification information, the bus identification information and the operation information are stored in a predetermined storage location of the operation database 21d in association with each other.

The communication device 22 is connected to the server 21 via the communication line built within the operation management center 20. Then, the communication device 22 is configured to realize communications to/from the operation information terminal device 11 and the information terminal device 30 by being connected to the network 40. Accordingly, the communication device 22 transmits the operation schedule information to the operation information terminal device 11, and receives therefrom the bus identification information and the operation information. Further, the communication device 22 receives the user identification information and the reservation information from the information terminal device 30, and transmits thereto the operation schedule information, operation situation information indicating an operation situation of the on-demand bus 10 based on the operation information, and decline information indicating that the user's request (demand) cannot be met in regard to the use of the on-demand bus 10.

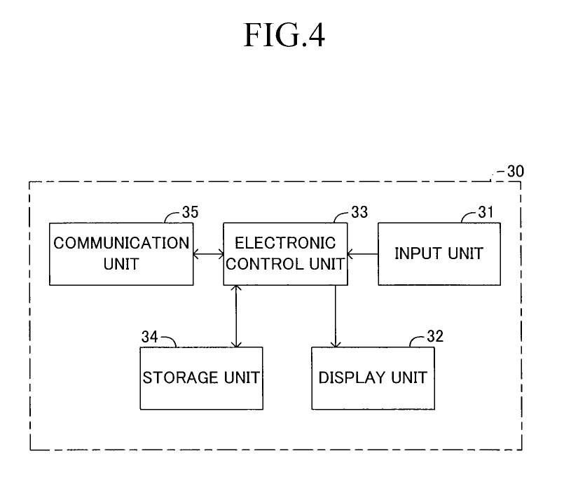

The information terminal device 30 is configured to be operated by the user to transmit the reservation information to the operation management center 20 and receive the operation schedule information, the operation situation information, and the decline information from the operation management center 20 in the form of, for example, character data using electronic mail or a voice call. For this reason, as illustrated in FIG. 4, the information terminal device 30 includes an input unit 31, a display unit 32, an electronic control unit 33, a storage unit 34, and a communication unit 35 that are communicably connected to one another. The input unit 31 is formed of, for example, a keyboard, a touch panel keyboard built in the display unit 32 for detecting a touch operation on a display panel of the display unit 32, or a speech input device capable of a call to/from an outside (specifically, operator resident in the operation management center 20). The display unit 32 is formed of, for example, a liquid crystal display, and displays a character, a graphic form, or the like on the display panel.

The electronic control unit 33 includes a microcomputer formed of a CPU, a ROM, a RAM, and the like as its main component part, and centrally controls operations of the input unit 31, the display unit 32, the storage unit 34, and the communication unit 35 by executing various application programs. The storage unit 34 stores the various application programs and various kinds of data used by the electronic control unit 33 to centrally control the operation of the information terminal device 30, and stores the user identification information (specifically, user ID information, password, and the like) necessary to access the operation management center 20 when transmitting the reservation information. The communication unit 35 is connected to the network 40 to implement a function of transmitting/receiving the user identification information, the reservation information, the operation schedule information, the decline information, speech data, and the like to/from the operation management center 20.

Here, specific examples employed as the information terminal device 30 include a mobile phone such as a smartphone, a tablet information terminal, and a laptop personal computer. Note that, it should be understood in this case that, for example, a desktop personal computer placed at home or the like and a fixed-line phone placed at home or the like can be used irrespective of inferior portability thereof.

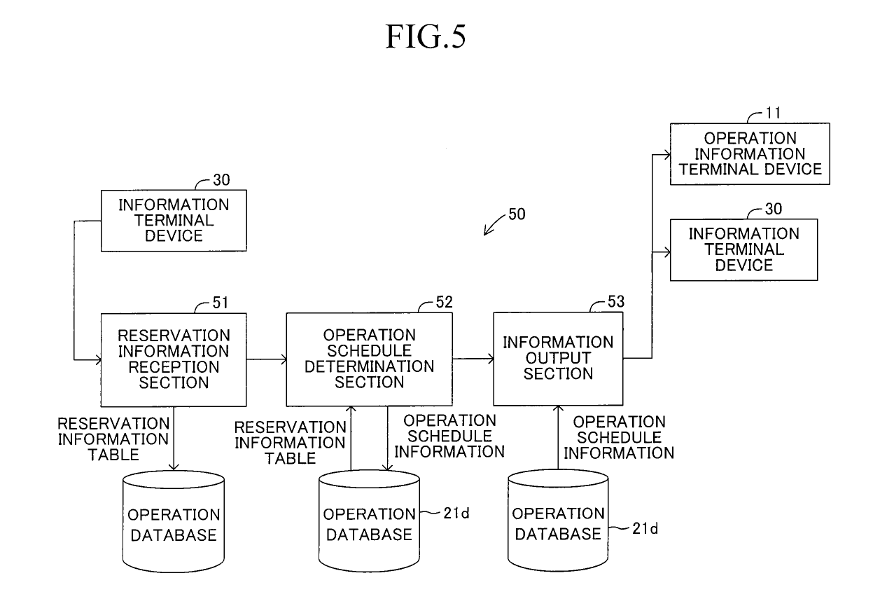

Next, the operation of the embodiment configured as described above is described with reference to a functional block diagram. As illustrated in FIG. 5, the server 21 (more specifically, control device 21a) of the operation management center 20 according to this embodiment includes an operation management section 50 formed of a reservation information reception section 51, an operation schedule determination section 52, and an information output section 53. Note that, although not being described in detail, the server 21 of the operation management center 20 is configured to collect congestion information (such as congestion degree or driving time required in the road segment or a predetermined segment) on each road (or road segment such as segment between intersections), weather conditions, the operation information (current location of the on-demand bus 10), and the like as current information on a region (zone) within which the on-demand bus 10 is being operated, and to store the current information in the operation database 21d. Further, the number of on-demand buses 10 is appropriately determined based on an area of an operation region (operation zone) and the number of users, and is further determined based on shopping streets, hospitals, public facilities, topographic features (such as presence/absence of a slope), a time slot, and the like. Note that, in this case, by preparing the on-demand bus 10 that is not assigned to the operation region (operation zone), it is possible to carry out the operation so as to specially assign the prepared on-demand bus 10 to the region (zone) that has a small number of users who desire a ride in accordance with the request (demand) received from the user.

The reservation information reception section 51 serving as information acquisition means receives the reservation information to be transmitted (transferred) to the operation management center 20 by the user to request (demand) the use of the on-demand bus 10. In other words, the reservation information reception section 51 receives, from the user, a desired boarding location onto the on-demand bus 10, a desired drop-off location from the on-demand bus 10, a desired boarding time onto the on-demand bus 10, a desired drop-off time from the on-demand bus 10, a boarding allowable additional time period that can be added before/after the desired boarding time, and a drop-off allowable additional time period that can be added before/after the desired drop-off time, as the reservation information. Note that, in the following description, the desired boarding time and the boarding allowable additional time period are also referred to collectively as “desired boarding time slot”, and the desired drop-off time and the drop-off allowable additional time period are also referred to collectively as “desired drop-off time slot”.

Here, the user can use the information terminal device 30 owned by himself/herself to transmit the reservation information to the operation management center 20, and can use, for example, a fixed-line phone placed at home or the like to transfer the reservation information to the operator resident in the operation management center 20 in the form of a call using voice. The transmission (transfer) of the reservation information is concisely described below mainly by taking a case of using the information terminal device 30.

When the user uses the information terminal device 30 to transmit the reservation information to the operation management center 20, the user activates a predetermined application program provided from the operation management center 20 in order to transmit the reservation information on the information terminal device 30. Then, the user uses the input unit 31 of the information terminal device 30 to input, in accordance with this predetermined application program, the desired boarding location, the desired drop-off location, the desired boarding time, the boarding allowable additional time period, the desired drop-off time, and the drop-off allowable additional time period.

Here, the user is allowed to input, as the boarding allowable additional time period and the drop-off allowable additional time period, time periods that can be allowed by himself/herself and includes the desired boarding time and the desired drop-off time, and allowed to make selection from among a longest time period (for example, 1.5 hours), a regular time period (for example, 1.0 hour), and a shortest time period (for example, 0.5 hours). Note that, in the following description, as the boarding allowable additional time period and the drop-off allowable additional time period designated by the user, the reservation information in which the longest time period is designated is referred to as “any leisurely reservation”, the reservation information in which the regular time period is designated is referred to as “regular reservation”, and the reservation information in which the shortest time period is designated is referred to as “spot reservation”. When the reservation information is input in this manner, the electronic control unit 33 of the information terminal device 30 transmits the input reservation information and the user identification information stored in the storage unit 34 to the operation management center 20 via the communication unit 31.

On the operation management center 20, the reservation information reception section 51 uses the communication device 22 to acquire and receive the reservation information and the user identification information transmitted from the information terminal device 30 of the user. Then, the reservation information reception section 51 inputs each corresponding item of the received reservation information to the reservation information table, which is provided in advance and which includes at least the desired boarding time, the boarding allowable additional time period, the desired drop-off time, the drop-off allowable additional time period, the desired boarding location, and the desired drop-off location as input items. When each item of the reservation information table is input based on the received reservation information, the reservation information reception section 51 stores the reservation information table and the received user identification information in a predetermined storage location of the operation database 21d in association with each other in a searchable manner. Note that, in this case, for example, when the user's home is designated as the desired boarding location or the desired drop-off location, the reservation information reception section 51 stores the user's home address or the latitude and longitude of the user's home registered in the operation database 21d in advance in the reservation information table in association therewith.

Note that, when the user transfers the reservation information to the operator of the management center 20 in the form of, for example, a call, the operator first acquires and receives the user's full name and the reservation information, namely, the desired boarding location, the desired drop-off location, the desired boarding time, the boarding allowable additional time period, the desired drop-off time, and the drop-off allowable additional time period, from the user in the form of a call. Then, although not shown, the operator uses an input unit (for example, keyboard) provided to the operation management center 20 to input each item of the received reservation information to the reservation information reception section 51. Further, the operator uses the acquired user's full name to acquire the user identification information registered in advance, and inputs the user identification information to the reservation information reception section 51. Accordingly, the reservation information reception section 51 stores the reservation information table on which each item input by the operator has been reflected and the input user identification information in a predetermined storage location of the operation database 21d in association with each other in a searchable manner.

Here, in a case where the user uses the on-demand bus 10, as described later, it is necessary to determine the operation schedule by securing an available on-demand bus 10. In other words, in order to secure an available on-demand bus 10 to determine the operation schedule, a certain amount of time period is necessary. For this reason, the reservation information reception section 51 is configured to transmit the decline information to the user if a time period from the current time until, at least, the desired boarding time is designated so as to be equal to or smaller than a predetermined time period when the reservation information is acquired. That is, the reservation information reception section 51 is configured to keep receiving the reservation information until at least a time point when the predetermined time period can be secured, and to stop receiving the reservation information after a time point when the predetermined time period cannot be secured.

The operation schedule determination section 52 serving as operation schedule determination means determines the operation schedule of the on-demand bus 10 based on the reservation information table stored in the operation database 21d by the reservation information reception section 51. The determination of the operation schedule is specifically described below by taking an exemplary situation in which a user “A”, a user “B”, a user “C”, and a user “D” transmit the reservation information to use the on-demand bus 10.

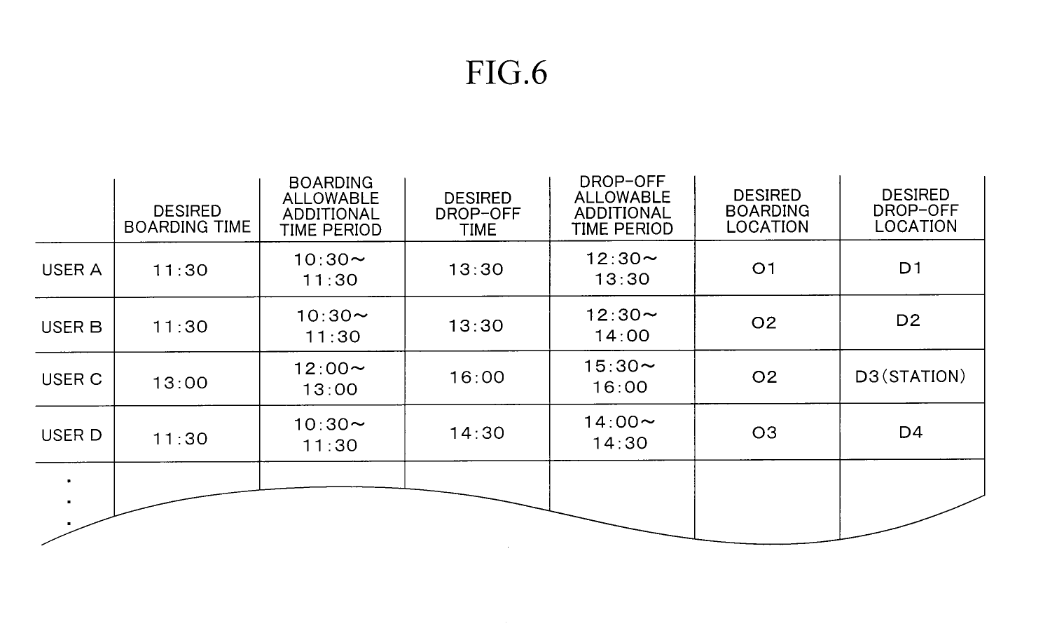

In this case, as shown in the reservation information table of FIG. 6, the user “A” designates, based on the regular reservation, 11:30 as the desired boarding time, designates 1.0 hour between 10:30 and 11:30 as the boarding allowable additional time period, designates 13:30 as the desired drop-off time, designates 1.0 hour between 12:30 and 13:30 as the drop-off allowable additional time period, designates a point O1 as the desired boarding location, and designates a point D1 as the desired drop-off location. The user “B” designates, based on the regular reservation, 11:30 as the desired boarding time while designating 1.0 hour between 10:30 and 11:30 as the boarding allowable additional time period, designates, based on the any leisurely reservation, 13:30 as the desired drop-off time while designating 1.5 hours between 12:30 and 14:00 as the drop-off allowable additional time period, designates a point O2 as the desired boarding location, and designates a point D2 as the desired drop-off location.

The user “C” designates, based on the regular reservation, 13:00 as the desired boarding time while designating 1.0 hour between 12:00 and 13:00 as the boarding allowable additional time period, designates, based on the spot reservation, 16:00 as the desired drop-off time while designating 0.5 hours between 15:30 and 16:00 as the drop-off allowable additional time period, designates the point O2 as the desired boarding location, and designates a point D3 (station) as the desired drop-off location. The user “D” designates, based on the regular reservation, 11:30 as the desired boarding time while designating 1.0 hour between 10:30 and 11:30 as the boarding allowable additional time period, designates, based on the spot reservation, 14:30 as the desired drop-off time while designating 0.5 hours between 14:00 and 14:30 as the drop-off allowable additional time period, designates a point O3 as the desired boarding location, and designates a point D4 as the desired drop-off location.

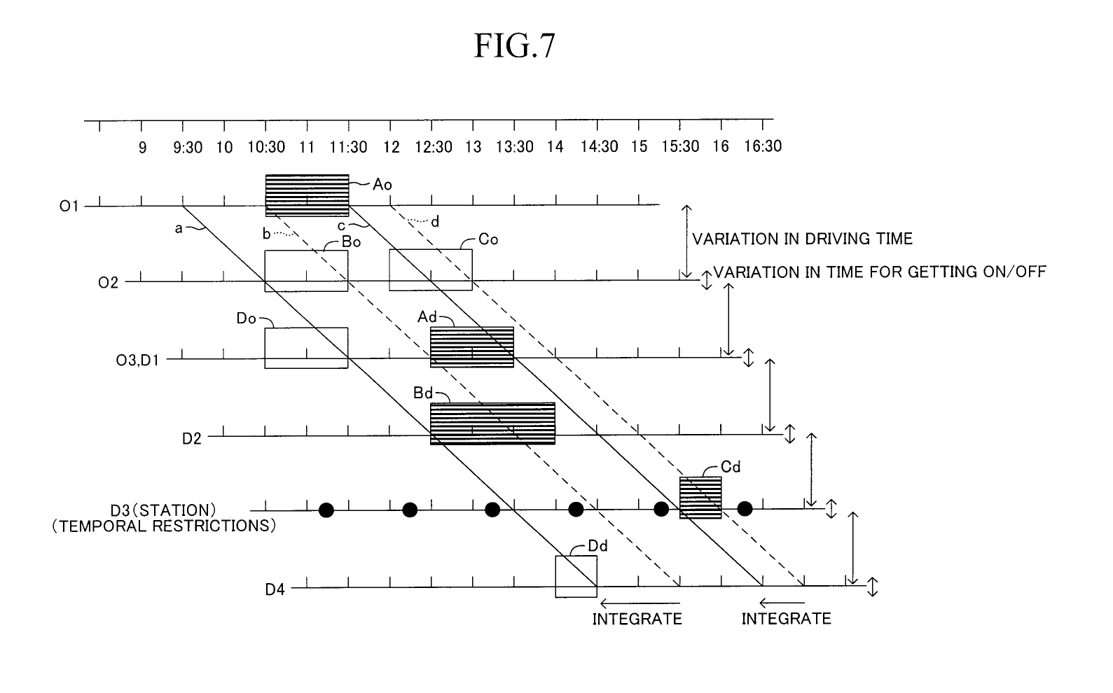

Then, the operation schedule determination section 52 creates such a timing chart as illustrated in FIG. 7 based on each piece of reservation information input to the reservation information table shown in FIG. 6. Accordingly, in accordance with the created timing chart, in consideration of each combination of the desired boarding time slots and the desired drop-off time slots respectively designated by the user “A” to the user “D”, the operation schedule determination section 52 determines the operation schedule of the on-demand bus 10 passing through the desired boarding time slots and the desired drop-off time slots. In other words, the operation schedule determination section 52 first searches the reservation information table stored in the predetermined storage location of the operation database 21d, to extract the reservation information on each of the user “A” to the user “D” input to the reservation information table.

Subsequently, the operation schedule determination section 52 acquires the desired boarding location and the desired drop-off location from among the respective pieces of extracted reservation information, and sets time axes indicating time periods (times) so as to correspond to the desired boarding location and the desired drop-off location that have been acquired. Note that, when the time axes are set, for example, in a case where the desired boarding location or the desired drop-off location is a station, a bus stop, or the like of a public transportation (such as train or route bus) whose operation times are determined in advance, the operation schedule determination section 52 sets, on the time axis, departure times and the like of the public transportation determined in advance, that is, restricted temporally as illustrated in the point D3 illustrated in FIG. 7.

Subsequently, as illustrated in FIG. 7, the operation schedule determination section 52 sets the respective desired boarding time slots (namely, desired boarding times and boarding allowable additional time periods) and the desired drop-off time slots (desired drop-off times and drop-off allowable additional time periods), which have been acquired, on the time axes corresponding to the desired boarding location and the desired drop-off location which are set as described above. Then, as illustrated in FIG. 7, the operation schedule determination section 52 sets a plurality of straight lines passing through at least the desired boarding time slots and the desired drop-off time slots set on the time axes, as operation schedule candidates for the on-demand bus 10. When a plurality of operation schedule candidates are set in this manner, the operation schedule determination section 52 determines, from among the plurality of set operation schedules, an operation schedule that allows a plurality of users to use one on-demand bus 10, that is, an operation schedule corresponding to the straight line passing through the desired boarding time slots and the desired drop-off time slots that are designated by the plurality of users. The determination of the operation schedule is specifically described below by taking an example with reference to FIG. 7.

Now, in the timing chart illustrated in FIG. 7, in consideration of each combination of the desired boarding time slots and the desired drop-off time slots, it is possible to set a straight line “a”, a straight line “b”, a straight line “c”, and a straight line “d” serving as the straight lines passing through those time slots as the operation schedule candidates. In other words, as illustrated in FIG. 7, the straight line “a” indicated by the solid line is a straight line passing through a desired boarding time slot Bo set for a desired boarding location O2 of the user “B”, a desired boarding time slot Do set for a desired boarding location O3 of the user “D”, a desired drop-off time slot Bd set for a desired drop-off location D2 of the user “B”, and a desired drop-off time slot Dd set for a desired drop-off location D4 of the user “D”. Further, the straight line “b” indicated by the broken line is a straight line passing through a desired boarding time slot Ao set for a desired boarding location O1 of the user “A”, the desired boarding time slot Bo of the user “B”, a desired drop-off time slot Ad set for a desired drop-off location D1 of the user “A”, and the desired drop-off time slot Bd of the user “B”. Further, the straight line “c” indicated by the solid line is a straight line passing through the desired boarding time slot Ao of the user “A”, a desired boarding time slot Co set for the desired boarding location O2 of the user “C”, the desired drop-off time slot Ad of the user “A”, and a desired drop-off time slot Cd set for a desired drop-off location D3 (station) of the user “C”. In addition, the straight line “d” indicated by the broken line is a straight line passing through the desired boarding time slot Co and the desired drop-off time slot Cd of the user “C”.

Subsequently, among the straight line “a” to the straight line “d” serving as the operation schedule candidates, the operation schedule determination section 52 excludes the straight line “d” from the operation schedules because of being the straight line passing only through the desired boarding time slot Co and the desired drop-off time slot Cd of the user “C”. Further, in regard to the straight line “a” and the straight line “b”, the straight line “a” is the straight line passing through the desired boarding time slots Bo and Do and the desired drop-off time slots Bd and Dd of the user “B” and the user “D”, and the straight line “b” is the straight line passing through the desired boarding time slots Ao and Bo and the desired drop-off time slots Ad and Bd of the user “A” and the user “B”.

In this case, when the straight line “b” is determined as the operation schedule, the straight line “a” becomes a straight line passing only through the desired boarding time slot Do and the desired drop-off time slot Dd of the user “D”, and the straight line “c” becomes a straight line passing only through the desired boarding time slot Co and the desired drop-off time slot Cd of the user “C”. For this reason, the straight line “a” and the straight line “c” are excluded from the operation schedules, and the operation schedule in which the user “C” and the user “D” use the on-demand bus 10 is no longer established. Therefore, the operation schedule determination section 52 determines the straight line “a” as the operation schedule, and excludes the straight line “b” from the operation schedules. Further, the straight line “c” is the straight line passing through the desired boarding time slots Ao and Co and the desired drop-off time slots Ad and Cd of the user “A” and the user “C”, and hence the operation schedule determination section 52 determines the straight line “c” as the operation schedule.

Here, it is assumed that the operation schedule is determined when the user “A” to the user “D” designate only the desired boarding time and the desired drop-off time without providing the boarding allowable additional time period and the drop-off allowable additional time period, that is, without providing the desired boarding time slot and the desired drop-off time slot. In this case, the operation schedule determination section 52 determines, in principle, the operation schedule so as to satisfy the operation of the on-demand bus 10 requested (demanded) by the user “A” to the user “D”.

For this reason, as described above, the user “A” designates 11:30 as the desired boarding time at the desired boarding location O1 and designates 13:30 as the desired drop-off time at the desired drop-off location D1, and hence the operation schedule determination section 52 needs to determine, for example, the operation schedule indicated by the straight line “c” so as to satisfy the request (demand) made by the user “A”. Further, as described above, the user “B” designates 11:30 as the desired boarding time at the desired boarding location O2 and designates 13:30 as the desired drop-off time at the desired drop-off location D2, and hence the operation schedule determination section 52 needs to determine, for example, the operation schedule indicated by the straight line “b” so as to satisfy the request (demand) made by the user “B”. Further, as described above, the user “C” designates 13:00 as the desired boarding time at the desired boarding location O2 and designates 16:00 as the desired drop-off time at the desired drop-off location D3 (station), and hence the operation schedule determination section 52 needs to determine, for example, the operation schedule indicated by the straight line “d” so as to satisfy the request (demand) made by the user “C”. In addition, as described above, the user “D” designates 11:30 as the desired boarding time at the desired boarding location O3 and designates 14:30 as the desired drop-off time at the desired drop-off location D4, and hence the operation schedule determination section 52 needs to determine, for example, the operation schedule indicated by the straight line “a” so as to satisfy the request (demand) made by the user “D”.

In other words, in this manner, when the boarding allowable additional time period and the drop-off allowable additional time period are not provided, in particular, when the desired boarding time slot Ao and the desired drop-off time slots Ad, Bd, and Cd illustrated in FIG. 7 are not provided, it is necessary to determine four operation schedules in order to satisfy the requests (demands) made by the user “A” to the user “D”. That is, four on-demand buses 10 need to be operated independently of one another, which increases the number of operations. Therefore, it becomes difficult to ensure profitability, which raises a fear that a fare borne by the user in order to ensure the profitability may increase. Further, for example, when the number of on-demand buses 10 that can be operated is limited, there is a fear that the on-demand bus 10 operated in accordance with the operation schedule that satisfies the requests (demands) made by the user “A” to the user “D” cannot be secured, and there is another fear that a frequency at which the decline information is transmitted to the user who has transmitted the reservation information may increase. Therefore, there is a fear that it may become difficult to ensure satisfactory convenience of the user.

In contrast, as described above, when the user “A” to the user “D” respectively designate the boarding allowable additional time periods and the drop-off allowable additional time periods, namely, designate the desired boarding time slots and the desired drop-off time slots, in accordance with their own schedules, the combination of those additional time periods (time slots) acts as a so-called buffer, and it is possible to determine the operation schedule that satisfies the requests (demands) made by the user “A” to the user “D” with a small number of operations. Specifically, the user “A” and the user “C” each use one on-demand bus 10 in the above-mentioned assumption, but by designating the boarding allowable additional time periods and the drop-off allowable additional time periods (desired boarding time slots and desired drop-off time slots), the operation schedule of the straight line “d” can be integrated into the operation schedule of the straight line “c”, and it is possible to satisfy the requests (demands) made by the user “A” and the user “C” with one on-demand bus 10. Further, the user “B” and the user “D” each use one on-demand bus 10 in the above-mentioned assumption, but by designating the boarding allowable additional time periods and the drop-off allowable additional time periods (desired boarding time slots and desired drop-off time slots), the operation schedule of the straight line “b” can be integrated into the operation schedule of the straight line “a”, and it is possible to satisfy the requests (demands) made by the user “B” and the user “D” with one on-demand bus 10.

Note that, when the boarding allowable additional time period and the drop-off allowable additional time period (desired boarding time slot and desired drop-off time slot) are designated by the user of the on-demand bus 10, it is possible to appropriately absorb a certain amount of variation in time even in a case where, for example, the driving time of the on-demand bus 10 that travels between boarding/drop-off points varies due to transportation conditions and the like or boarding/drop-off time periods necessary for the user's getting on/off vary. This allows the on-demand bus 10 to arrive within the desired boarding time slot and within the desired drop-off time slot, with the result that the number of operations of the on-demand bus 10 can be effectively suppressed from increasing.

In this manner, when the straight line “a” and the straight line “c” indicating the operation schedules of the on-demand buses 10 are determined on the timing chart, the operation schedule determination section 52 stores the operation schedules indicated by the straight line “a” and the straight line “c” that have been determined in a predetermined storage location of the operation database 21d. Specifically, the operation schedule determination section 52 stores the operation schedule (hereinafter referred to as “first operation schedule”) in which, in accordance with the timing chart illustrated in FIG. 7, as the operation schedule indicated by the straight line “a”, the on-demand bus 10 is dispatched to the boarding location O2 by 10:30, arrives at the boarding location O3 at 11:30, arrives at the drop-off location D2 at 12:30, and arrives at the drop-off location D4 at 14:30. Further, the operation schedule determination section 52 stores the operation schedule (hereinafter referred to as “second operation schedule”) in which, in accordance with the timing chart illustrated in FIG. 7, as the operation schedule indicated by the straight line “c”, the on-demand bus 10 is dispatched to the boarding location O1 by 11:30, arrives at the boarding location O2 at 12:30, arrives at the drop-off location D1 at 13:30, and arrives at the drop-off location D3 (station) at 15:30.

The information output section 53 serving as information providing means outputs (provides), to the user, the operation schedule information indicating the operation schedules determined by the operation schedule determination section 52 and the operation situation information on the determined operation schedules. A specific description thereof is made below in accordance with the above-mentioned example.

In the above-mentioned example, in accordance with the timing chart illustrated in FIG. 7, the operation schedule determination section 52 determines the first operation schedule employed for the on-demand bus 10 to be used by the user “B” and the user “D” and the second operation schedule employed for the on-demand bus 10 to be used by the user “A” and the user “C”. Therefore, the information output section 53 transmits the operation schedule information indicating the first operation schedule and the operation situation information to the respective information terminal devices 30 of the user “B” and the user “D”, and transmits the operation schedule information indicating the second operation schedule and the operation situation information to the respective information terminal devices 30 of the user “A” and the user “C”. Note that, in this manner, when the operation schedule information is transmitted, it is recognized that the reservation information transmitted by each of the user “A” to the user “D” has been confirmed. Further, the operation schedule information indicating the first operation schedule is transmitted to the operation information terminal device 11 mounted to the on-demand bus 10 to be used by the user “B” and the user “D”, and the operation schedule information indicating the second operation schedule is transmitted to the operation information terminal device 11 mounted to the on-demand bus 10 to be used by the user “A” and the user “C”.

Then, in accordance with the first operation schedule, the information output section 53 transmits a guidance message of, for example, “Please get on an on-demand bus arriving at the desired boarding location O2 at 10:30.” to the information terminal device 30 of the user “B”. Further, in accordance with the positional information (more specifically, current positional information) serving as the operation information on the on-demand bus 10 acquired from the operation information terminal device 11 mounted to the corresponding on-demand bus 10, the information output section 53 transmits, to the information terminal device 30, the operation situation information (status information) of, for example, “The on-demand bus will arrive late due to traffic congestion.” a predetermined time period before the user “B” gets on the corresponding on-demand bus 10 or “The on-demand bus will soon arrive.” a few minutes before the user “B” gets on the corresponding on-demand bus 10. Accordingly, the user “B” can get on the on-demand bus 10 based on the desired boarding location O2 and the desired boarding time slot Bo requested (demanded) by himself/herself through the reservation information, and can get off the on-demand bus 10 based on the desired drop-off location D2 and the desired drop-off time slot Bd.

Further, in accordance with the first operation schedule, the information output section 53 transmits a guidance message of, for example, “Please get on an on-demand bus arriving at the desired boarding location O3 at 11:30.” to the information terminal device 30 of the user “D”. Further, in the same manner as the case of the user “B”, in accordance with the current positional information on the on-demand bus 10, the information output section 53 transmits the operation situation information (status information) to the information terminal device 30 of the user “D”. Accordingly, the user “D” can get on the on-demand bus 10 based on the desired boarding location O3 and the desired boarding time slot Do requested (demanded) by himself/herself through the reservation information, and can get off the on-demand bus 10 based on the desired drop-off location D4 and the desired drop-off time slot Dd.

Further, in accordance with the second operation schedule, the information output section 53 transmits a guidance message of, for example, “Please get on an on-demand bus arriving at the desired boarding location O1 at 11:30.” to the information terminal device 30 of the user “A”. Further, in accordance with the positional information (more specifically, current positional information) serving as the operation information on the on-demand bus 10 acquired from the operation information terminal device 11 mounted to the corresponding on-demand bus 10, the information output section 53 transmits, to the information terminal device 30, the operation situation information (status information) of, for example, “The on-demand bus will arrive late due to traffic congestion.” a predetermined time period before the user “A” gets on the corresponding on-demand bus 10 or “The on-demand bus will soon arrive.” a few minutes before the user “A” gets on the corresponding on-demand bus 10. Accordingly, the user “A” can get on the on-demand bus 10 based on the desired boarding location O1 and the desired boarding time slot Ao requested (demanded) by himself/herself through the reservation information, and can get off the on-demand bus 10 based on the desired drop-off location D1 and the desired drop-off time slot Ad.

In addition, in accordance with the second operation schedule, the information output section 53 transmits a guidance message of, for example, “Please get on an on-demand bus arriving at the desired boarding location O2 at 12:30.” to the information terminal device 30 of the user “C”. Further, in the same manner as the case of the user “A”, in accordance with the current positional information on the on-demand bus 10, the information output section 53 transmits the operation situation information (status information) to the information terminal device 30 of the user “C”. Accordingly, the user “C” can get on the on-demand bus 10 based on the desired boarding location O2 and the desired boarding time slot Co requested (demanded) by himself/herself through the reservation information, and can get off the on-demand bus 10 based on the desired drop-off location D3 (station) and the desired drop-off time slot Cd. Note that, the user “C” gets off the on-demand bus 10 at the temporally restricted station. In this case, when the on-demand bus 10 arrives at the station within the desired drop-off time slot Cd designated by the user “C”, the user “C” can positively get on the public transportation (train or route bus).

Incidentally, the user who has used the on-demand bus 10 can pay the fare by using, for example, a prepaid or postpaid electronic money card or electronic payment through the short-range wireless communications between the operation information terminal device 11 and the information terminal device 30 (such as mobile phone or smartphone). In this manner, by using the electronic money card or the information terminal device 30 to pay the fare or charge within a short time period, it is possible to shorten the boarding/drop-off time periods of the on-demand bus 10, which allows the operation to be performed in accordance with the determined operation schedule.

As can be understood from the description made above, according to the above-mentioned embodiment, the user who uses the on-demand bus 10 can designate the boarding allowable additional time period and the drop-off allowable additional time period (desired boarding time slot and desired drop-off time slot), and the operation schedule determination section 52 determines the operation schedule in consideration of (by adding) the combination of those additional time periods (time slots), which can appropriately suppress the number of operations from increasing without impairing the convenience of the user. In this manner, by determining the efficient and rational operation schedule, it is possible to operate the on-demand bus 10 while ensuring the profitability, with the result that the fare (cost) borne by the user can be appropriately suppressed from increasing.

In the above-mentioned embodiment, it is described that the user designates the boarding allowable additional time period and the drop-off allowable additional time period, that is, designates the desired boarding time slot and the desired drop-off time slot, to thereby be able to efficiently operate the on-demand bus 10 and effectively reduce the number of operations. In this case, in the case where the user designates the boarding allowable additional time period and the drop-off allowable additional time period (desired boarding time slot and desired drop-off time slot), the larger number of operations of the on-demand bus 10 can be integrated when the “regular reservation” (namely, time slot longer than the spot reservation) is designated rather than when the “spot reservation” (namely, short time slot) is designated, and further, the number of operations of the on-demand bus 10 can be integrated more easily when the “any leisurely reservation” (namely, time slot longer than the regular reservation) is designated than when the “regular reservation” is designated. Therefore, when the user designates the boarding allowable additional time period and the drop-off allowable additional time period (desired boarding time slot and desired drop-off time slot), it is possible to prompt the user to set those additional time periods (time slots) longer. A modification example of the above-mentioned embodiment is specifically described below, while the same components as those of the above-mentioned embodiment are denoted by the same reference symbols, and descriptions thereof are omitted.

Also in this modification example, the user can use the information terminal device 30 owned by himself/herself to transmit the reservation information to the operation management center 20, and can use, for example, a fixed-line phone placed at home or the like to transfer the reservation information to the operator resident in the operation management center 20 in the form of a voice call. Therefore, in the same manner as in the above-mentioned embodiment, the following description is made mainly by taking the case where the user uses the information terminal device 30 to transmit (transfer) the reservation information.

Also in this modification example, when the user uses the information terminal device 30 to transmit the reservation information to the operation management center 20, the user activates a predetermined application program provided from the operation management center 20 in order to transmit the reservation information on the information terminal device 30. Then, in the same manner as in the above-mentioned embodiment, the user uses the input unit 31 of the information terminal device 30 to input and designate, in accordance with this predetermined application program, the desired boarding location, the desired drop-off location, the desired boarding time, the boarding allowable additional time period, the desired drop-off time, and the drop-off allowable additional time period.

At this time, in the predetermined application program according to this modification example, when the user inputs the boarding allowable additional time period and the drop-off allowable additional time period, it is presented as a gain to be given to the user that the fare for the on-demand bus 10 is changed depending on lengths of the boarding allowable additional time period and the drop-off allowable additional time period. In other words, in the predetermined application program according to this modification example, when the boarding allowable additional time period and the drop-off allowable additional time period are input, it is presented to the user, for example, that the fare is lower when the “regular reservation” is selected than when the “spot reservation” is selected and that the fare is lower when the “any leisurely reservation” is selected than when the “regular reservation” is selected. Note that, in this case, as the gain, instead of discounting the fare, for example, it is also possible to increase a rate at which a point, which is given for each use of the on-demand bus 10 and can also be used for the payment of the fare, is given.

Accordingly, for the user who transmits the reservation information, for example, while the “spot reservation” may be selected irrespective of its relatively high fare without any choice in a temporally restricted situation such as a situation in which the on-demand bus 10 is used to travel to the station before transferring to a train, it is easier for the user to select the “regular reservation” or the “any leisurely reservation” that lowers the fare in a situation in which temporal restrictions are not placed on the travel using the on-demand bus 10. When the user inputs the boarding allowable additional time period and the drop-off allowable additional time period, the fare (gain) determined depending on the lengths of input (designated) time periods is presented to the user.

In this manner, by prompting the user to easily select the “regular reservation” or the “any leisurely reservation” when the boarding allowable additional time period and the drop-off allowable additional time period are input, as described in the above-mentioned embodiment, it is possible to determine the operation schedule that allows a plurality of users to use one on-demand bus 10 to travel. In other words, the operation of the on-demand bus 10 can be integrated more easily, with the result that the on-demand bus 10 can be operated efficiently while ensuring the profitability, which can alleviate the fare borne by the user.

In carrying out the present invention, the present invention is not limited to each of the above-mentioned embodiments and modification example, and different kinds of changes can be made without departing from an object of the present invention.

For example, the above-mentioned embodiment and modification example are carried out so as to provide the operation schedule information and the operation situation information (status information) to the user who has transmitted (transferred) the reservation information to the operation management center 20. In this case, it is preferred to operate the on-demand bus 10 more efficiently by increasing a usage rate (rate of the number of occupied seats to the number of set seats) thereof. For this reason, the information output section 53 cooperates with, for example, the reservation information reception section 51 and the operation schedule determination section 52, to determine whether or not the usage rate of the on-demand bus 10 is lower than a predetermined usage rate.

When the usage rate of the on-demand bus 10 is lower than the predetermined usage rate, the information output section 53 can provide the user who does not have a reservation for the use of the on-demand bus 10 with, for example, the usage rate of the on-demand bus 10 that is currently operating (or is to operate), that is, vacancy information indicating the number of vacant seats. Accordingly, for example, when the user who needs to use the on-demand bus 10 on urgent business uses the on-demand bus 10 that has been informed of, it is possible to increase the usage rate of the on-demand bus 10, which can operate the on-demand bus 10 more efficiently while increasing the profitability. Therefore, also in this case, the same effect as in the above-mentioned embodiment and modification example can be obtained.

Note that, in this case, the information output section 53 can extract, for example, the user who is likely to use the operation schedule determined by the operation schedule determination section 52 this time based on the past reservation information table stored in the predetermined storage location of the operation database 21d, to provide the extracted user with the operation schedule information and the vacancy information.

Further, the above-mentioned embodiment and modification example are carried out so that the operation schedule determination section 52 determines, in principle, the operation schedule of the on-demand bus 10 without changing the reservation information transmitted (transferred) by the user. In this case, for example, in a situation in which a given user has selected the boarding allowable additional time period (namely, desired boarding time slot) as the “regular reservation”, when the number of operations of the on-demand bus 10 can be reduced by causing the boarding allowable additional time period to be selected as the “any leisurely reservation”, the operation schedule determination section 52 can cooperate with the reservation information reception section 51 and the information output section 53 to request the user to change the reservation information. In this case, when the user agrees to change the reservation information in response to the request, for example, it is possible to give a bonus such as a discount on the fare for the on-demand bus 10. In this manner, the same effect as in the above-mentioned embodiment and modification example can also be obtained by requesting the change of the reservation information and determining the operation schedule based on the changed reservation information.

Further, the above-mentioned embodiment and modification example are carried out so that the user performs setting by selecting from among the “any leisurely reservation”, the “regular reservation”, and the “spot reservation”, for which the time lengths are set in advance, when designating the boarding allowable additional time period and the drop-off allowable additional time period, namely, designating the desired boarding time slot and the desired drop-off time slot. In this case, the above-mentioned embodiment and modification example can also be carried out so that the user designates the boarding allowable additional time period and the drop-off allowable additional time period, namely, the desired boarding time slot and the desired drop-off time slot by setting such an arbitrary length as to fall within a predetermined range. With this configuration, the same effect as in the above-mentioned embodiment and modification example can also be obtained.

Further, the above-mentioned embodiment and modification example are carried out so that the desired boarding time slot is formed of the desired boarding time and the boarding allowable additional time period added before and after the desired boarding time and that the desired drop-off time slot is formed of the desired drop-off time and the drop-off allowable additional time period added before and after the desired drop-off time. In other words, the above-mentioned embodiment and modification example are carried out so that the user designates the desired boarding time and the desired drop-off time as the reservation information and designates the boarding allowable additional time period and the drop-off allowable additional time period. In this case, the above-mentioned embodiment and modification example can be carried out so that, as the reservation information, the designation of the desired boarding time and the desired drop-off time is omitted, the desired boarding time slot is indicated by the boarding allowable additional time period, and the desired drop-off time slot is indicated by the drop-off allowable additional time period. Also in this case, the desired boarding time slot and the desired drop-off time slot are designated by the user, and hence the same effect as in the above-mentioned embodiment and modification example can be obtained.

In addition, the above-mentioned embodiment and modification example are carried out by providing the on-demand vehicle operation management device according to the present invention to the operation management center 20. In this case, the above-mentioned embodiment and modification example can be carried out so that, for example, the operation information terminal device 11 (more specifically, electronic control unit 11a) mounted to the on-demand bus 10 and the information terminal device 30 (more specifically, the electronic control unit 33) owned by the user realize operations equivalent to those of the reservation information reception section 51, the operation schedule determination section 52, and the information output section 53 that form the above-mentioned operation management section 50, separately or in cooperation with each other. Also in this case, the same effect as in the above-mentioned embodiment and modification example can be obtained.

1. An on-demand vehicle operation management device, comprising operation management means for creating an operation schedule of an on-demand vehicle based on requests received from a plurality of users and managing an operation of the on-demand vehicle in accordance with the created operation schedule,
wherein the operation management means is configured to:
acquire pieces of information serving as the requests received from the plurality of users and each comprising at least a desired boarding location at which to get on the on-demand vehicle, a desired boarding time slot within which to get on the on-demand vehicle at the desired boarding location, a desired drop-off location at which to get off the on-demand vehicle, and a desired drop-off time slot within which to get off the on-demand vehicle at the desired drop-off location; and
determine the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot.

2. An on-demand vehicle operation management device according to claim 1, wherein the desired boarding time slot and the desired drop-off time slot are designated by each of the plurality of users who use the on-demand vehicle.

3. An on-demand vehicle operation management device according to claim 1, wherein:
the desired boarding time slot comprises a desired boarding time at which to get on the on-demand vehicle and boarding allowable additional time periods that are added before and after the desired boarding time and are allowable for each of the plurality of users who use the on-demand vehicle; and
the desired drop-off time slot comprises a desired drop-off time at which to get off the on-demand vehicle and drop-off allowable additional time periods that are added before and after the desired drop-off time and are allowable for the each of the plurality of users.

4. An on-demand vehicle operation management device according to claim 1, wherein the desired boarding time slot and the desired drop-off time slot are selected from among a plurality of time slots set in advance.

5. An on-demand vehicle operation management device according to claim 1, wherein the operation management means provides the plurality of users with operation schedule information indicating the determined operation schedule, and provides the plurality of users with operation situation information indicating an operation situation of the on-demand vehicle operating in accordance with the determined operation schedule.

6. An on-demand vehicle operation management device according to claim 1, wherein the operation management means is configured to:
determine a gain to be given to each of the plurality of users who use the on-demand vehicle depending on lengths of the desired boarding time slot and the desired drop-off time slot; and
present the determined gain to the each of the plurality of users.

7. An on-demand vehicle operation management device according to claim 6, wherein the operation management means is configured to:
determine the gain to be given to the each of the plurality of users so that the gain becomes smaller as the lengths of the desired boarding time slot and the desired drop-off time slot become shorter; and
determine the gain to be given to the each of the plurality of users so that the gain becomes larger as the lengths of the desired boarding time slot and the desired drop-off time slot become longer.

8. An on-demand vehicle operation management device according to claim 6, wherein the gain to be given to the each of the plurality of users relates to a fare charged when the on-demand vehicle is used.

9. An on-demand vehicle operation management method for creating an operation schedule of an on-demand vehicle based on requests received from a plurality of users and managing an operation of the on-demand vehicle in accordance with the created operation schedule, the on-demand vehicle operation management method comprising:
acquiring pieces of information serving as the requests received from the plurality of users and each comprising at least a desired boarding location at which to get on the on-demand vehicle, a desired boarding time slot within which to get on the on-demand vehicle at the desired boarding location, a desired drop-off location at which to get off the on-demand vehicle, and a desired drop-off time slot within which to get off the on-demand vehicle at the desired drop-off location;
determining the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot; and
providing the plurality of users with operation schedule information indicating the determined operation schedule, and providing the plurality of users with operation situation information indicating an operation situation of the on-demand vehicle operating in accordance with the determined operation schedule.

10. An on-demand vehicle operation management method according to claim 9, further comprising:
determining, depending on lengths of the desired boarding time slot and the desired drop-off time slot, a gain to be given to each of the plurality of users who use the on-demand vehicle so that the gain becomes smaller as the lengths of the desired boarding time slot and the desired drop-off time slot become shorter and that the gain becomes larger as the lengths of the desired boarding time slot and the desired drop-off time slot become longer; and
presenting the determined gain to the each of the plurality of users.

11. An on-demand vehicle operation management system, comprising:
an on-demand vehicle to be ridden by a plurality of users;
an operation management center for creating an operation schedule of the on-demand vehicle based on requests received from the plurality of users, and managing an operation of the on-demand vehicle in accordance with the created operation schedule; and
an information terminal device for supplying the request to the operation management center by being operated by each of the plurality of users,
wherein the operation management center is configured to:
acquire pieces of information serving as the requests supplied by the information terminal devices from the plurality of users and each comprising at least a desired boarding location at which the each of the plurality of users is to get on the on-demand vehicle, a desired boarding time slot within which the each of the plurality of users is to get on the on-demand vehicle at the desired boarding location, a desired drop-off location at which the each of the plurality of users is to get off the on-demand vehicle, and a desired drop-off time slot within which the each of the plurality of users is to get off the on-demand vehicle at the desired drop-off location;
determine the operation schedule for operating the on-demand vehicle, in consideration of a combination of the desired boarding time slots and the desired drop-off time slots within the respective pieces of information acquired from the plurality of users, so that the plurality of users each get on the on-demand vehicle at the desired boarding location within the desired boarding time slot and get off the on-demand vehicle at the desired drop-off location within the desired drop-off time slot; and
provide the plurality of users with operation schedule information indicating the determined operation schedule via the information terminal devices, and provide the plurality of users with operation situation information indicating an operation situation of the on-demand vehicle operating in accordance with the determined operation schedule via the information terminal devices.

12. An on-demand vehicle operation management system according to claim 11, wherein the operation management center is further configured to:
determine, depending on lengths of the desired boarding time slot and the desired drop-off time slot, a gain to be given to the each of the plurality of users who use the on-demand vehicle so that the gain becomes smaller as the lengths of the desired boarding time slot and the desired drop-off time slot become shorter and that the gain becomes larger as the lengths of the desired boarding time slot and the desired drop-off time slot become longer; and
present the determined gain to the each of the plurality of users via the information terminal device.
